(19) United States
(12) Patent Application Publication
(10) Pub. No.: US 2013/0094028 A1
(43) Pub. Date: Apr. 18, 2013

(54) COHERENCE GRID -- INTERFEROMETER AND METHOD FOR A SPATIALLY RESOLVED OPTIC MEASUREMENT OF THE SURFACE GEOMETRY OF AN OBJECT

(71) Applicant: Polytec GmbH, Waldbronn (DE)

(72) Inventors: Christian Rembe, Waldbronn (DE); Sebastian Boedecker, Karlsruhe (DE); Markus Grittmann, Karlsruhe (DE)

(73) Assignee: Polytec GmbH, Waldbronn (DE)

(21) Appl. No.: 13/647,488

(22) Filed: Oct. 9, 2012

(30) Foreign Application Priority Data
Oct. 7, 2011 (DE) 102011115027.0

(51) Int. Cl. G01B 9/02

(52) U.S. Cl. CPC G01B 9/0209
USPC 356/497

(57) ABSTRACT

A coherence grid—interferometer for spatially resolved optic measurement of an object, with a light source, an interferometer, a path length—altering unit, and camera with a detection area. The interferometer cooperates with the light source and camera such that an outgoing beam is split into a measuring beam and a reference beam, the measuring beam is at least partially reflected by the object to the detection area of the camera and overlapped via a beam splitter with the reference beam such that the overlapped beams overlap the photo sensors in a planar fashion, and the optic path length—altering unit changes the optic path length of the measuring and/or reference beams. The path length—altering unit has a path scale and a path detector which detect a changing length of the optic path of the measuring and/or reference beams and the interferogram records are synchronized with the path measurement.

### INCORPORATION BY REFERENCE

The following documents are incorporated herein by reference as if fully set forth: German Patent Application No. 102011115027.0, filed Oct. 7, 2011.

### BACKGROUND

The invention relates to a coherence grid—interferometer for a spatially resolved optic measurement of data regarding elevation geometry of an object as well as a method for a spatially resolved measurement of the surface profile of an object using a coherence grid—interferometer.

The spatially resolved optic measurement of the data regarding elevation geometry of an object using a coherence grid—interferometer is known per se:

Here, a light beam generated by a light source is split by an interferometer into a measuring beam and a reference beam, with the measuring beam being guided planar to the object to be measured and the measuring beam being at least partially reflected and/or scattered by the object to a detection area of a camera and interfered with the reference beam. The camera comprises a plurality of photo sensors, typically a CCD-chip so that one measuring point on the object is allocated to each photo sensor, for example each pixel of a CCD-chip.

Using an optic path length—altering unit the path length of the measuring beam or reference beam is altered. This typically occurs by displacing the entire coherence grid—interferometer in reference to the object.

The coherence grid—interferometer comprises an incoherent light source, so that an interference signal is only generated on the photo sensor of the camera when the optic paths for the reference beam and the measuring beam are adjusted. By determining the position of the interferometer, in which a maximum interference contrast is given for the respective photo sensor, here information regarding an elevation can be allocated to each photo sensor and thus data regarding the elevation geometry of the object can be determined.

A coherence grid—interferometer is therefore characterized, when compared to a microscopic structure, particularly by displaying a large-area measuring field on a plurality of photo sensors. A coherence grid—interferometer is described in DE 10 2005 023 212, for example.

### SUMMARY

The present invention is based on the objective of improving the coherence grid—interferometer of prior art and the known method for a spatially resolved optic measurement of the data of elevation geometry of an object via a coherence grid—interferometer with regards to the precision of the measurement and/or the reproducibility of the measuring features.

This objective is attained in a coherence grid—interferometer as well as a method for the spatially resolved measurement of the data of the elevation geometry of an object including one or more features of the invention. Advantageous embodiments of the coherence grid—interferometer according to the invention and the method according to the invention are provided below and in the claims.

The coherence grid—interferometer according to the invention for a spatially resolved optic measuring of the data of elevation geometry of an object comprises a light source, an interferometer, a path length—altering unit, and a camera with a detection area. The detection area of the camera comprises a plurality of locally different photo sensors.

The interferometer is embodied cooperating with a light source and the camera such that an outgoing beam generated by the light source is split into a measuring beam and a reference beam. The measuring beam impinges the object in a planar fashion and the measuring beam at least partially reflected and/or scattered by the object and coupled back into the beam path of the interferometer and interfered with the reference beam on the detection area of the camera such that the interfered measuring beam and the reference beam cover the plurality of the photo sensors in a planar fashion. This is achieved using a lens and preferably a beam splitter by the measuring object and a reference plane being displayed on the field of the camera comprising photo sensors.

This is therefore consistent with the design of a coherence grid—interferometer of prior art in which a measuring area covered by the measuring beam is interfered on the object with the reference beam on the detection area of the camera such that one respectively locally different measuring point inside the measuring area on the object is allocated to each photo sensor of the camera.

Furthermore, the optic path length—altering unit is embodied to alter the optic path length of the measuring beam and/or the reference beam. This is also consistent with the design of prior art such that via an optic path length—altering unit the ratio between the path lengths between the measuring beam and the reference beam can be altered such that particularly a comparison of the path lengths is possible at maximum interference contrast for each individual photo sensor and thus each measuring point on the object inside the measuring area.

It is essential that the path length—altering unit of the coherence grid—interferometer according to the invention comprises a path scale and a path detector. The path scale and the path detector are arranged such that changes of the optic path length of the measuring beam and/or the reference beam occur by the path length—altering unit (lead to) a synchronous motion of the path detector in reference to the path scale.

The invention is based on the finding by the applicant that in coherence grid—interferometers of prior art the imprecision in the determination of the optic path length and/or the change of the optic path length is of decisive influence on the entire measuring precision for a certain photo sensor and the allocated measuring point on the object as well as the ability for accelerating the measuring process to save time. In prior art, other parameters or elements of the coherence grid—interferometer are optimized to increase the precision of measurements, however surprisingly it has shown that an increase in the precision of measurements during the changing the optic path length considerably improves the overall precision of measurement.

In coherence grid—interferometers of prior art the altering of the optic path length typically occurred by a motorized driving of a spindle by which the coherence grid—interferometer can be linearly displaced in reference to the object. Here the rotations of the spindle have been determined in order to draw conclusions from the change of the optic path length.

In the coherence grid—interferometer according to the invention the path length—altering unit comprises a path scale, separate from the mechanical drive component, and a path detector. Hereby, using commercial scales and detectors allocated thereto a considerable improvement of the precision is possible when determining the change of the path length.

In the coherence grid—interferometer according to the invention, by additionally providing a path scale and a path detector, the precision of measurement is considerably increased in a structurally beneficial, inexpensive fashion.

The method according to the invention for a spatially resolved measuring of the data regarding elevation geometry of an object using a coherence grid—interferometer is preferably performed using the coherence grid—interferometer according to the invention and/or an advantageous embodiment thereof. Additionally, the coherence grid—interferometer according to the invention is preferably embodied to perform the method according to the invention and/or an advantageous embodiment thereof.

The method according to the invention comprises the following processing steps:

In a processing step A the outgoing beam emitted by the light source is split into a measuring beam and a reference beam, with the reference beam impinging the object in a planar fashion, and the measuring beam, at least partially reflected and/or scattered, is interfered with the reference beam on a detection area of a camera in a planar fashion, with the detection area comprising a plurality of photo sensors at different positions.

In a processing step B an alteration of the optic path length of the measuring beam and/or the reference beam occurs and a recording of measuring images via the camera for several different path lengths of the measuring beam and/or the reference beam.

In a processing step C a determination of the data of the elevation geometry of the object occurs based on the measuring signals of the detectors for several measuring images.

This is equivalent to the method of prior art, that measuring images are recorded by the camera for different ratios of the optic path length between the measuring beam and the reference beam and thus can be determined for each photo sensor and also for each respectively allocated measuring point on the object with the maximum interference contrast and by allocating the respective alteration of the optic path length the data of the elevation geometry of the object can be prepared.

It is essential that in the method according to the invention, in a processing step B, a path detector is displaced in reference to a path scale simultaneous to the alteration of the optic path length and based on the measuring signals of the path detector path information is allocated to each measuring image.

This way the above-described advantage results that based on the separate measuring of the alteration of the path length via the path scale and the allocated path detector a considerable increase of the precision and the measuring of the change of the optic path length is yielded.

Preferably a straight scale is used as the path scale. This is advantageous since on the one side such scales are commercially available and allow in a simply designed fashion an allocation of the displacement of the path detector in reference to the straight scale and the change of the path length occurring here. In particular, very precise straight glass scales are commercially available. The detection of the displacement of the path detector in reference to the path scale can occur in a manner known per se, particularly in an optical, capacitive, and electromagnetic fashion.

In particular, the use of a temperature insensitive straight scale is advantageous, i.e. a scale showing no or only slight longitudinal extensions under temperature fluctuations. Here, too, glass scales are advantageous.

The path length—altering unit can be embodied in a manner known per se. The scope of the invention particularly includes that via the path length—altering unit a reflector can be displaced in the radiation path of the reference beam or the measuring beam so that the optic path length of the respective beam is altered. In particular it is advantageous to embody the path length—altering unit for a linear displacement of the coherence grid—interferometer in reference to the object. Here, the scope of the invention includes to displace the object in a stationary coherence grid—interferometer or in a cinematic inversion in case of a stationary object to displace the coherence grid—interferometer. It is known that preferably in a stationary object the coherence grid—interferometer is linearly displaced, because this way a particularly flexible and variable embodiment of the object fastener is possible. In particular, exchangeable object fasteners can be used, while the coherence grid—interferometer always rests on the unchanged, linear displacement unit of the optic path length—altering unit.

Experiments of the applicant have shown that in embodiments of the path length—altering unit for the linear displacement of the coherence grid—interferometer in reference to the object or for the linear displacement of an optic reflector in the radiation path of a measuring beam and reference beam it is advantageous for the path scale to be arranged along the direction of the linear displacement. When the optic path length is altered, here a displacement of the path scale or the path detector occurs parallel in reference to a linear displacement of the object, the coherence grid—interferometer, or the optic reflector from the radiation path of the measuring beam and/or the reference beam.

Here, an additional increase of the precision is yielded because any potential imprecision in the unit for the linear displacement, for example by play in case of a spindle drive, cannot lead to imprecise measurements because the linear displacement actually occurring is detected via the path scale and the path detector, independent of the fact if said linear displacement does or does not vary by a mechanically caused imprecision.

Furthermore, potential displacements with a component perpendicular in reference to a linear displacement generally show only little influence upon the change of the optic path length. The above-described preferred arrangement of the path scale parallel in the direction of the linear displacement therefore also represents a displacement perpendicular in reference to the linear direction of displacement and here also perpendicular in reference to the longitudinal extension of the path scale and therefore it causes no or only very little influence upon the measurement of the change of the optic path length.

Advantageously the coherence grid—interferometer according to the invention is embodied such that the radiation paths of the measuring beam and the reference beam are in one plane. This way it is possible, in particular, to allocate the path scale in this plane of the radiation paths in an advantageous manner. This way the measuring precision is increased because motions and particular linear motions in the plane of the radiation paths can be determined by the path scale and motions outside the plane of the radiation paths, which also show only little influence upon the alteration of the optic path length, accordingly also show only little influence upon the measuring of the alteration of the optic path length via the path scale and the path detector.

Preferably the path scale is arranged parallel in reference to the optic axis of the measuring beam between the interferometer and the object or parallel in reference to the optic axis of the measuring beam between the interferometer and a deflection mirror for reflecting the measuring beam to the object. In particular it is advantageous for the optic axis of the measuring beam and the longitudinal extension of the path scale to show a distance of <1 cm, preferably <2 mm, further preferred <1 mm. This way, too, the measuring precision is provided due to the above-mentioned circumstances: Such changes relating to the path length of the measuring beam are detected by this configuration of the path measuring via the path scale and the path detector, while such motions causing no or only little change of the optic path length accordingly show no or only little effects upon the measurement of the optic alteration of the path length. The above-defined distance shall be considered in the mathematical sense as a distance between two parallel lines, i.e. the distance formed by the shortest straight line perpendicular in reference to the lines between said lines, with one line being defined by the optic axis of the measuring beam and the other line by the longitudinal extension of the path scale.

Advantageously the optic path length—altering unit comprises a linear guide, which serves for linearly displacing at least the relevant optic components in order to change the optic path length. These optic components may comprise a reflector, for example, which as described above is arranged in the radiation path of the measuring beam or the reference beam and in this preferred embodiment can be displaced via the linear guide. Additionally, the scope of the invention includes in a preferred embodiment to displace the interferometer or the essential components thereof via the linear guide in reference to the object.

When using a linear guide it is advantageous if the linear guide is also located in the above-mentioned plane of the radiation paths of the measuring beam and the reference beam and/or the path scale is arranged parallel in reference to the direction of displacement of the linear guide.

Advantageously the coherence grid—interferometer comprises an evaluation unit, which is electrically connected to the detector and the path detector and is embodied such that a synchronization of the measuring signals of the path detector occurs via the measuring signals of the camera. In particular, it is advantageous that depending on the signals of the path detector a recording of the measuring image occurs for predetermined path positions via the camera and/or that the evaluation unit sends trigger signals to the camera for recording a measuring image and simultaneously with the issue of the trigger signal the path position is determined depending on the measuring signals of the path detector. The method according to the invention is preferably embodied such that depending on the measuring signals of the path detector one measuring image each is recorded for the predetermined path positions.

In this advantageous embodiment therefore path positions can be predetermined with regards to the change of the optic path length for with one measuring image each being recorded for each of the path positions. This allows greater flexibility when performing the measuring process because the path positions equivalent to a lateral plane of the elevation profile on the object can be predetermined arbitrarily. In particular it is possible, for example in the probably relevant range, to predetermine a closer sequence of path positions for determining a camera image so that here the measurement occurs with higher precision and in the less relevant positions of elevation camera images are recorded at greater distances so that the measuring process can be accelerated, here.

Experiments of the applicant have shown that frequently the synchronization between the changes of the optic path length and the recording of the camera images is problematic in coherence grid—interferometers of prior art. The coordination between the speed of the drive system to change the optic path length, on the one side, and the recording of the camera images to be “synchronized” thereto, which is limited particularly by the maximum recording rate of the camera and/or its photo sensors, such as for example a CCD-chip with a respective evaluation unit, is frequently not ensured in systems of prior art.

This particularly applies for continuous measurements, i.e. measurements in which via the optic path length—altering unit at least an approximately continuous change of the optic path length occurs and during the continuous change a plurality of measurements is performed. Here, the change of the optic path length is preferably continuous to the extent that the change occurs with an approximately constant speed, preferably with speeds varying by less than 10%, preferably by less than 5%, particularly by less than 1%. Preferably, during the constant change of the path length at least 15 measurements occur, preferably at least 30, further preferred at least 100.

Preferably the coherence grid—interferometer according to the invention shows therefore a speed control by which at least a constant speed can be optionally predetermined for the change of the path length. In this preferred embodiment therefore the speed can be adjusted to the desired measuring situation. In particular it is possible to select the speed such that for predetermined path positions the frequency required for recording camera images does not exceed the maximally possible recording frequency of the camera for recording measuring images and particularly equidistant predetermined path positions. Furthermore, in a preferred embodiment the determination of the speeds of the change of the path length can advantageously occur by assessing the measuring signals of the path detector, because via the path scale and the path detector a very precise determination of the change of the path length and thus also a very precise determination of the change of speed of the path length is possible in a simple fashion. The maximally possible camera image rate Kᵣ[1/s] is therefore preferably referenced to the target speed of the path length—altering unit vₛ[m/s], the target z-path between 2 camera images Δzₛ[m], and the maximum percental z-speed variations vp [%] via the following formula 1:

$${K}_{r} \geq \frac{{v}_{S}}{Δ {z}_{S}} ( \frac{100 \% + vp}{100 \%} ) \qquad ( Formula 1 )$$

Experiments of the applicant have shown that vp is preferably selected in the range 5% to 15%.

This is based on the common definition of coordinates, according to which the measuring object essentially extends in a xy-plane and the information of elevation to determine the data of elevation geometry is determined in a z-direction perpendicular in reference to said plane.

Therefore, in this preferred embodiment, according to the method according to the invention, the change of the path length occurs with a constant speed and the camera images can either (be recorded) with a predetermined frequency under synchronous determination of the path position for each camera image. Additionally it is possible in methods with constant speeds to predetermine path positions, particularly equidistant path positions, at which one camera image each is recorded.

The exposure time is here selected to be as short as possible because excessive exposure times lead to the intensity contrast of the camera images worsening. However, the exposure time must be selected so long that the dynamic range of the camera (preferably 8 or 12 bit) is utilized. Preferably the exposure time tint must fulfill the formula 2

$${t}_{int} \leq \frac{{λ}_{0}}{{v}_{S} \cdot 16} \qquad ( formula 2 )$$

with λ₀ being equivalent to the average wavelength of the light source and vₛ the target feed rate of the path length—altering unit.

Typical light sources show wavelengths in the visible range. In particular, the use of a light source with an average wavelength within the visible range is included in the scope of the invention, particularly an average wavelength ranging from 520 nm to 540 nm.

In a preferred embodiment, a pulse operation of the light source can be used as an alternative to determining the exposure time when the camera exposure time cannot be selected short enough. In particular it is here advantageous to synchronize the pulse operation of the light source with the optic wavelength—altering unit such that upon reaching each predetermined measuring position a light pulse of the light source is triggered.

Preferably, in the method according to the invention measuring images are recorded by the camera with a predetermined frequency and respective path positions are determined synchronous to recording a measuring image based on the measuring signal of the path detector. In particular, here it is advantageous for the predetermined frequency to range from 80% to 100%, preferably from 90% to 99% of the maximum trigger frequency of the photo sensors of the camera. In this preferred embodiment here an optimization of the measuring speed is yielded, because on the one side the camera images are recorded with an almost maximum frequency using a low safety deduction, and on the other side it is also ensured that the maximum recording frequency of the camera is not exceeded.

Alternatively, in a preferred embodiment of the method according to the invention, the altering of the optic path length occurs continuously with a predetermined speed as described above in a processing step B, which speed being selected such that measuring images are recorded for predetermined, equidistant path positions and the recording frequency is here lower than the predetermined maximum recording frequency of the camera.

As described above, the coherence grid—interferometer according to the invention is embodied for the planar display of a measuring range to be overlapped with the reference beam on the detection area of the camera. For this purpose, the coherence grid—interferometer according to the invention preferably comprises at the output of the measuring beam at the side of the object a numeric aperture <0.1, preferably 0.025, further preferred less than 0.013.

In another preferred embodiment the coherence grid—interferometer according to the invention comprises a planar reference mirror in a manner known per se, which reference mirror being arranged in the radiation path of the reference beam. In particular it is advantageous for the path length—altering unit to be embodied preferably parallel in reference to the optic axis of the reference beam in the proximity of the reference mirror for a linear displacement of said reference mirror. This way, a changing of the optic path length of the reference beam is yielded in a simple design.

The optic path length—altering unit preferably comprises an electric motor. Here, the use of a stepper motor is advantageous due to the ability for precise controlling. However flutters can occur in stepper motors, which is disadvantageous. Thus, preferably a stepper motor with a viscous-elastic damper is provided in order to ensure even speed. Furthermore, it is advantageous to embody the stepper motor control for even speed with regards to the curve of the circuit diagram. The scope of the invention also includes to use an electric direct current motor.

Here the light source is preferably embodied similar to one of coherence grid—interferometers of prior art. In particular the light source shows preferably a coherence length <20 μm, preferably <10 μm.

The coherence grid—interferometer according to the invention is preferably embodied such that the measuring range on the object, i.e. the area on the object impinged by the measuring beam, which is displayed on the detection area of the camera and overlapped by the reference beam, covers a rectangular area of at least (16×12) mm², preferably at least (20×14) mm², further preferred at least (35×25) mm². Preferably the coherence grid—interferometer is embodied such that at least differences in elevation in the z-direction can be measured amounting to 150 μm, preferably at least 5 mm, further preferred at least 50 mm, further preferred at least 100 mm. This way, the measuring of objects with a respectively high band width of elevation points is possible. Particularly the optic path length—altering unit is preferably embodied such that a change of the optic path length can be implemented amounting to at least 150 μm, preferably at least 5 mm, further preferred of at least 50 mm, further preferred at least 100 mm.

The measuring range on the object and the reference plane are preferably displayed via a telecentric optic on the field comprising the photo sensors of the camera.

### BRIEF DESCRIPTION OF THE DRAWINGS

In the following, further preferred features and preferred embodiments of the coherence grid—interferometer according to the invention and the method according to the invention are explained in greater detail using the exemplary embodiments and the figures. Shown are:

FIG. 1 is a schematic illustration of a coherence grid—interferometer according to the invention in a top view;

FIG. 2 is a cross-section of the illustration according to FIG. 1 along a sectional line shown as a dot-dash line in FIG. 1, with the sectional plane extending perpendicular in reference to the drawing plane in FIG. 1,

FIG. 3 is a schematic flow chart of a first exemplary embodiment of a control of a coherence grid—interferometer;

FIG. 4 is a schematic flow chart of a second exemplary embodiment of a control of the coherence grid—interferometer according to the invention, and

FIG. 5 is a schematic flow chart of a third exemplary embodiment of the control of the coherence grid—interferometer according to the invention.

### DETAILED DESCRIPTION OF THE PREFERRED EMBODIMENTS

In the figures the reference characters mark identical elements or elements with identical functions.

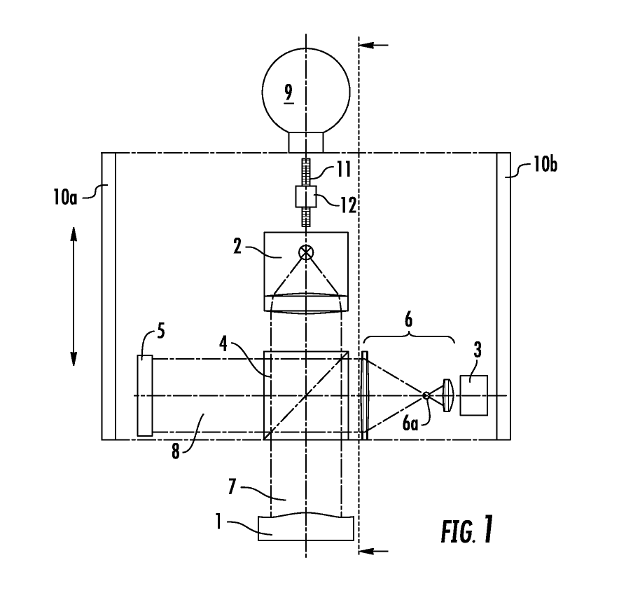

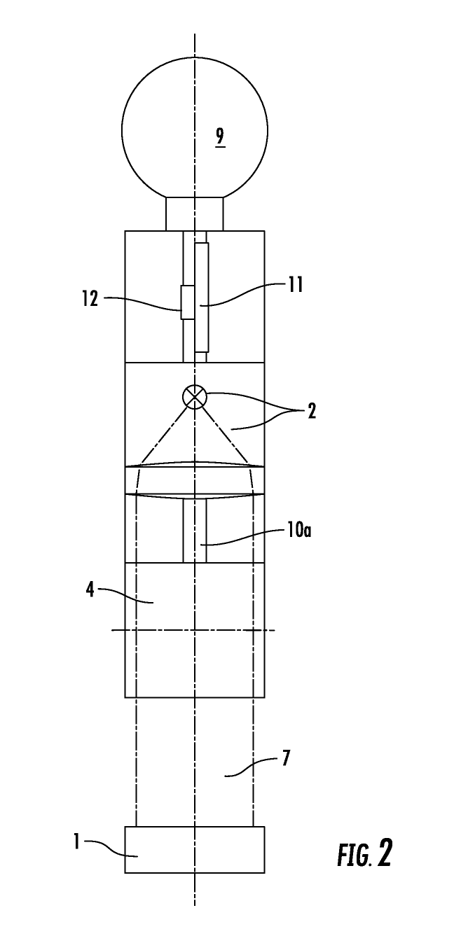

The exemplary embodiment of the coherence grid—interferometer according to the invention shown in FIGS. 1 and 2 serves for spatially resolved optic measurements of the data of the elevation geometry of an object 1.

The coherence grid—interferometer comprises a light source 2 as well as a camera 3, which is preferably embodied as a CCD-camera and thus comprises a CCD—chip with a plurality of pixels, which pixels therefore show a plurality of photo sensors.

The coherence grid—interferometer further comprises an interferometer, which includes a beam splitter 4, a reference mirror 5, as well as a telecentric display optic 6 with a pinhole 6a.

The interferometer is embodied cooperating with the light source 2 and the camera such that a beam, generated by the light source, and widened in a planar fashion by a lens arrangement of the light source, is split by the beam splitter 4 into a measuring beam 7 and a reference beam 8. The reference beam impinges the object 1 to be measured and the measuring beam 7, at least partially reflected by the object 1, returns into the radiation path of the interferometer and is displayed via the beam splitter and the display optic 6 on the detection area of the camera 3. The reference beam 8 impinges the reference mirror 5, passes the beam splitter 4, and is also displayed via the display optic 6 on the camera 3 such that the measuring beam and the reference beam are interfered on the detection area of the camera 3.

The coherence grid—interferometer further comprises a path length—altering unit comprising a motor 9 and a spindle drive, not shown.

The light source 2, the camera 3, and the components of the interferometer are arranged on a common sled, which in a top view according to FIG. 1 shows at both sides linear guides 10a and 10b. Using the motor 9, by way of rotating the spindle the above-mentioned sled and thus the components light source, camera, and interferometer can be displaced in reference to the object, with guiding occurring here and thus a straight motion is ensured by the linear guides 10a and 10b. By this displacement here the distance between the optic components of the coherence grid—interferometer and the object 1 can be increased and reduced.

This way, a change of the optic path length of the measuring beam 7 occurs: the motor 9 and the spindle drive, not shown, are therefore components of an optic path length—altering unit.

A particularly robust embodiment results when the sled is displaced horizontally and thus the weight of the components to be displaced acts perpendicular in reference to the direction of displacement. However, even in this embodiment the measuring beam can impinge the measuring object via a deflection mirror from any arbitrary direction. In particular, it is frequently advantageous to allow the measuring beam impinging the object via the deflection mirror from the top.

In FIGS. 1 and 2 a processing and control unit is not shown, which is connected to at least the motor 9 and the camera 3 and which it generally controls, according to a control scheme known per se for determining data of an elevation geometry of the object 1, via a coherence grid—interferometer.

For several vertical distances between the optic components of the coherence grid—interferometer and the object 1, one camera image is recorded each so that for every pixel of the detection area of the camera and thus each measuring point on the object 1 allocated to the respective pixel the distance can respectively be determined with the maximum interference contrast (coherence maximum) and based on this data a surface elevation map of the object 1 is prepared.

It is essential that the path length—altering unit of the exemplary embodiment shown in FIGS. 1 and 2 of a coherence grid—interferometer according to the invention further shows a path scale 11 and a path detector 12.

The path scale 11 is here arranged stationary, while the path detector 12 is arranged at the sled of the optic components of the interferometer and the camera. During the linear displacement via the motor 9 in the vertical direction therefore synchronously a displacement of the path detector 12 occurs in reference to the path scale 11.

The path scale 11 is embodied as a linearly straight scale. It may preferably be embodied as a glass scale. In this exemplary embodied the path detector 12 is formed as an optic path detector, which generates measuring signals depending on the optic markers on the linear path scale 11.

The evaluation and control unit is further connected to the path detector 12 so that based on its signal a precise detection of the distance occurs between the coherence grid—interferometer and the object 1.

Using the motor 9 and the spindle drive, not shown, here the optic components of the interferometer, the light source 2, the camera 3, and the path detector 12 are displaced linearly in the vertical direction. The above-mentioned components are arranged at a common, stiff sled so that in the above-mentioned linear displacement the above-mentioned components do not shift in reference to each other. This sled is called a positioning unit, together with the components arranged thereon.

The interferometer according to the exemplary embodiment shown in FIGS. 1 and 2 is embodied as a Michelson-interferometer in which therefore the planar reference plane embodied by the reference mirror 5 and the measuring surface on the object 1 by a lens system, particularly comprising the display optic 6, are overlapped on the detection area of the camera 3. As described above, a vertical displacement of the interferometer, the light source, and the camera 3 occurs in reference to the object 1 via the motor 9 and accordingly the spindle drive. The linear displacement occurs here parallel in reference to the progression of the measuring beam 7 between the beam splitter 4 and the object 1.

The light source 2 exhibits a coherence length of approximately 8 μm.

In the exemplary embodiments of the coherence grid—interferometer according to the invention shown in FIGS. 1 and 2 here a considerably higher precision can be achieved for determining the data of elevation geometry of the object 1 due to the high precision of the path measurements via the path scale 11 and the path detector 12.

As described above, it is decisive for the measuring principle of coherence grid—interferometer with regards to the measuring precision that the detection of the interference signals of positions to be precisely determined by the camera, particularly the optic components of the interferometer, occurs in reference to the object. Here it is advantageous when the image recording of the camera is triggered and reaching a certain target position triggers the camera action. Here, it must be observed that the period between two trigger signals amounts to at least a term required by the camera for recording two images because otherwise image information can get lost.

The scope of the invention includes that the camera is triggered with a maximum image rate and for each trigger the position is measured via the path detector 12 and according to the camera image recorded allocated via the evaluation and control unit. It is also possible that one trigger signal each occurs for predetermined path positions in order to perform the recording of a camera image and it is ensured that the displacement speed is selected such that the maximum image rate of the camera is not exceeded.

The exemplary embodiment of the interferometer according to the invention shown in FIGS. 1 and 2 therefore comprise a speed control, not shown, for the motor 9. This way, on the one side maximum speed can be achieved during the displacement to reduce the necessary measuring period and simultaneously it can be ensured that the maximum image rate of the camera is not exceeded.

For this purpose, the speed control is either independent from the path detection or the path detection is used to detect any potential deviations from the target speed and compensate the speed control via feedback.

Advantageously the control occurs such that potential positioning errors are not compensated because such compensation can lead to speed peaks, which in turn cause the trigger signal occurring too early, with the camera not yet being ready for recording.

In the exemplary embodiment of the coherence grid—interferometer according to the invention shown in FIGS. 1 and 2 the path scale 11 is arranged with regards to its longitudinal extension on the optic axis of the measuring beam 7, which in turn is parallel in reference to the linear displacement to change the optic path length of the measuring path 7. This way, error sources, for example by pitch-angles due to mechanic tolerances of the linear guides 10a and 10b, are excluded or at least minimized.

Furthermore, the linear guide is also located at the plane of the optic axis. This additionally counteracts an error due to a pitching, as described above.

Furthermore, it is discernible in FIG. 2 that the radiation paths of the interferometer are located in a plane, which in FIG. 2 is vertical and perpendicular in reference to the drawing plane. The path scale 11 is arranged with regards to its longitudinal extension in this plane such that here measuring errors are excluded or at least minimized, perhaps caused by tilting errors due to mechanic tolerances. This way an Abbe-error is minimized.

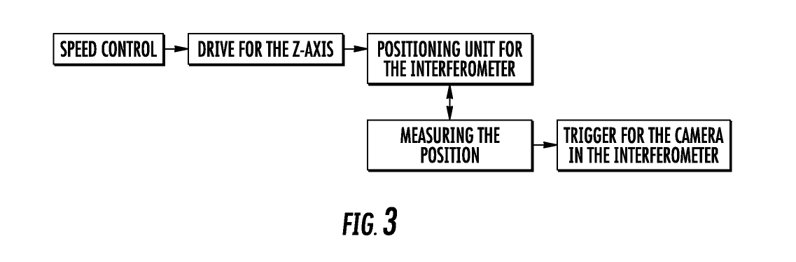

FIGS. 3 to 5 show three exemplary embodiments of a method according to the invention for a spatially resolved measuring of the data of elevation geometry of an object using a coherence grid—interferometer according to FIGS. 1 and 2 in schematic details.

All three exemplary embodiments of the method according to the invention have in common that the processing steps A, B, and C, are realized as described above, and furthermore the measuring of the change of the optic path length, in this case the measuring beam, occurs via the path scale 11 and the path detector 12.

In the first exemplary embodiment according to FIG. 3 the path positions are predetermined, at which a camera image shall be recorded. The path positions therefore describe different distances between the beam splitter 4 and the object 1.

Firstly a maximum speed is determined so that the time difference between reaching two adjacent path positions each is equivalent to the minimum period the camera 3 requires between two images. This maximum speed is reduced by a safety factor in order to allow for speed tolerances of the positioning unit. Typically a target-displacement speed according to formula 1 (here resolved according to vₛ) is determined

$${v}_{S} \leq \frac{100 \% Δ {z}_{S} {K}_{r}}{100 \% + vp}$$

in the present exemplary embodiment with vp=10%, Δzₛ=87 nm, and Kᵣ=30.1 Hz. A displacement speed determined in this manner is used via a speed control to control the motor 9 and thus to drive the z-axis, i.e. the spindle, which causes a linear vertical displacement to change the optic path length of the measuring beam 7. Accordingly the displacement occurs of the positioning unit for the interferometer. Simultaneously a positioning measurement occurs via the path detector 12 and the path scale 11. When reaching the predetermined path positions, a respective emission of a trigger signal occurs to the camera 3 to record the measuring image depending on the measuring signals of the path detector 12.

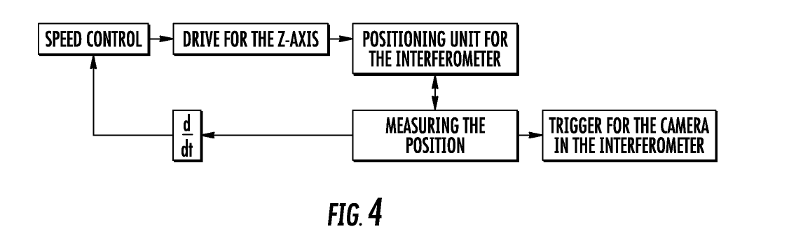

In an alternative embodiment of a second exemplary embodiment of the method according to the invention according to FIG. 4, contrary to the control scheme shown in FIG. 3, a feedback is given from the positioning measurement to the speed control. In this exemplary embodiment it is checked during the measurement if the next path position to record a camera image would be reached in a shorter period than the minimal time required by the camera between two images. If this is the case, feedback is given to the speed control for slowing the driving speed such, that the next path position to record a camera image is only reached upon expiration of the above-mentioned minimum period of the camera between two camera images.

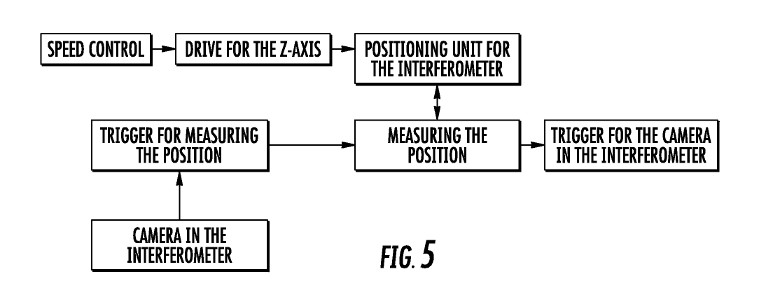

In a third exemplary embodiment of the method according to the invention according to FIG. 5 the displacement of the positioning unit occurs as described above based on a predetermined speed by the speed control addressing the drive for the z-axis. However, in this exemplary embodiment no path positions are predetermined to record camera images. Instead, the camera is triggered with a predetermined recording frequency, which recording frequency of course may not exceed the maximum recording frequency of the camera itself. Preferably the predetermined recording speed is approximately equivalent to the maximum recording frequency of the camera, in order to yield a measuring period as short as possible. Simultaneous to triggering the camera for recording a measuring image a trigger signal is given to assess the measuring signals of the path detector and thus to determine the present position so that the camera image is allocated to the path information presently given.

### LIST OF REFERENCE CHARACTERS

1 object
2 light source
3 camera
4 beam splitter
5 reference mirror
6 display optic
6a pinhole
7 measuring beam
8 reference beam
9 motor
10a, 10b linear guides
11 path scale
12 path detector

1. A coherence grid—interferometer for a spatially resolved optic measuring of data for elevation geometry of an object,
comprising a light source (2), an interferometer, a path length—altering unit, and a camera (3) with a detection area, said detection area comprises a plurality of locally different photo sensors, with the interferometer being embodied cooperating with the light source (2) and the camera (3) such that an outgoing beam emitted by the light source (2) is split into a measuring beam and a reference beam (8), with the measuring beam (7) impinging the object (1) in a planar fashion and at least partially reflected and/or portions of the measuring beam scattered by the object (1) being returned to the detection area of the camera (3) back into a radiation path of the interferometer and overlapped with the reference beam (8) such that the overlapped measuring beam and reference beam (8) cover the plurality of photo sensors, and the optic path length—altering unit being embodied to change an optic path length of at least one of the measuring beam or the reference beam, the path length—altering unit comprises a path scale (11) and a path detector (12) arranged such that upon changing the optic path length of the at least one of the measuring beam or the reference beam by the path length—altering unit, a synchronous motion of the path detector occurs in reference to the path scale (11).

2. A coherence grid—interferometer according to claim 1, wherein the path scale (11) is embodied as a straight scale.

3. A coherence grid—interferometer according to claim 1, wherein the path length—altering unit is embodied for linear displacement of the coherence grid—interferometer in reference to the object (1) or for the linear displacement of an optic reflector in the radiation path of the measuring beam or the reference beam, and the path scale (11) is arranged along a direction of the linear displacement.

4. A coherence grid—interferometer according to claim 1, wherein radiation paths of the measuring beam and the reference beam (8) are arranged in one plane and the path scale (11) is arranged in the same plane.

5. A coherence grid—interferometer according to claim 1, wherein the path scale (11) is arranged parallel in reference to an optic axis of the measuring beam between the interferometer and the object (1).

6. A coherence grid—interferometer according to claim 1, wherein the coherence grid—interferometer comprises an evaluation unit, which is electrically connected to the detector and the path detector (12) and is embodied such that a synchronization occurs of measuring signals of the path detector with the measuring signals of the camera (3).

7. A coherence grid—interferometer according to claim 1, wherein the path length—altering unit comprises a speed control, by which a constant speed can be predetermined for a continuous change of the path length.

8. A coherence grid—interferometer according to claim 1, wherein the interferometer comprises at an output of the measuring beam at an object side a numeric aperture of less than 0.1.

9. A coherence grid—interferometer according to claim 1, wherein the interferometer comprises a planar reference mirror (5), said reference mirror (5) being arranged in a radiation path of the reference beam, and the path length—altering unit is embodied for linearly displacing the reference mirror parallel in reference to an optic axis of the reference beam in proximity of the reference mirror.

10. A coherence grid—interferometer according to claim 1, wherein the light source (2) is embodied for generating a light beam with a coherence length of less than 20 μm.

11. A method for the spatially resolved measuring of data for elevation geometry of an object using a coherence grid—interferometer comprising the following processing steps:
A splitting an outgoing beam, generated by a light source (2), into a measuring beam and a reference beam (8), with the reference beam (8) impinging the object (1) in a planar fashion and with at least a partially reflected and/or disbursed part of the measuring beam (7) being overlapped by the reference beam (8) on a detection area of a camera (3), said detection area comprising a plurality of locally different measuring sensors,
B changing a length of the optic path of at least one of the measuring beam or the reference beam and recording measuring images via the camera (3) for several different lengths of optic paths of at least one of the measuring or the reference beam (8),
C determining an elevation profile of the object based on the measuring signals of the detectors for several measuring images,
Wherein in processing step B, synchronous to the changing of the length of the optic path, a path detector (12) is displaced in reference to a path scale (11) and based on measuring signals of the path detector, path information is allocated to each measuring image.

12. A method according to claim 11, wherein a straight measuring scale is used as the path scale (11).

13. A method according to claim 11, wherein depending on the measuring signals of the path detector, one measuring image each is recorded for predetermined path positions.

14. A method according to claim 11, further comprising recording predetermined frequency measuring images via the camera (3) and synchronous to the recording of the measuring image, determining a path position based on the measuring signals of the path detector, and the predetermined frequency ranges from 80% to 100% of a maximum trigger frequency of the photo sensors of the camera (3).

15. A method according to claim 11, wherein in processing step B the change of the optic path length occurs continuously with a predetermined speed, which speed is selected such that measuring images are recorded for predetermined, equidistant path positions and the recording frequency is lower than a predetermined maximum recording frequency of the camera (3).

16. A method according to claim 11, wherein the condition
$${v}_{S} \leq \frac{100 \% Δ {z}_{S} {K}_{r}}{100 \% + vp}$$
is fulfilled with a maximally possible camera image rate Kᵣ[1/s], a target speed of the z-axis vₛ[m/s], a target z-path between two camera recordings Δzₛ[m], and a maximum percentage variation of z-speed vp [%].
